(19) United States
(12) Patent Application Publication
(10) Pub. No.: US 2023/0136951 A1
(43) Pub. Date: May 4, 2023

(54) CONTROL DEVICE, VEHICLE GUIDANCE METHOD, AND VEHICLE GUIDANCE PROGRAM PRODUCT

(71) Applicant: DENSO CORPORATION, Kariya-city (JP)

(72) Inventors: Masatake WADA, Kariya-city (JP); Koudai YAMAURA, Kariya-city (JP); Takamasa HIDAKA, Kariya-city (JP)

(21) Appl. No.: 18/146,935

(22) Filed: Dec. 27, 2022

Related U.S. Application Data
(63) Continuation of application No. PCT/JP2021/026988, filed on Jul. 19, 2021.

(30) Foreign Application Priority Data
Jul. 22, 2020 (JP) 2020-125656

(51) Int. Cl. B60W 30/06; G08G 1/14

(52) U.S. Cl. CPC B60W 30/06; G08G 1/146

(57) ABSTRACT

A control device, which is used in an automated valet parking lot, includes: an availability determination unit determining an availability of a parking section included in a parking area, the parking area being defined as an area in which an autonomous driving of a vehicle is executed according to a guidance of the control device within the automated valet parking lot; and a vehicle guidance unit guiding an entrance vehicle to the parking section according to the availability of the parking section determined by the availability determination unit, the entrance vehicle corresponding to the vehicle that requests an entrance to the parking section. When the availability determination unit determines that the parking section is unavailable, the vehicle guidance unit guides the entrance vehicle to a passage included in the parking area.

### CROSS REFERENCE TO RELATED APPLICATION

The present application is a continuation application of International Patent Application No. PCT/JP2021/026988 filed on Jul. 19, 2021, which designated the U.S. and claims the benefit of priority from Japanese Patent Application No. 2020-125656 filed on Jul. 22, 2020. The entire disclosures of all of the above applications are incorporated herein by reference.

### TECHNICAL FIELD

The present disclosure relates to a control device used in an automated valet parking lot.

### BACKGROUND

An automated valet parking lot includes a parking area, which is an area where autonomous driving is performed according to a guidance of a control device. For example, when there is a vehicle requesting entry into a parking section in the parking area, the control device guides the vehicle to an empty parking section.

### SUMMARY

The present disclosure provides a control device, which is used in an automated valet parking lot. The control device includes: an availability determination unit determining an availability of a parking section included in a parking area, the parking area being defined as an area in which an autonomous driving of a vehicle is executed according to a guidance of the control device within the automated valet parking lot; and a vehicle guidance unit guiding an entrance vehicle to the parking section according to the availability of the parking section determined by the availability determination unit, the entrance vehicle corresponding to the vehicle that requests an entrance to the parking section. When the availability determination unit determines that the parking section is unavailable, the vehicle guidance unit guides the entrance vehicle to a passage included in the parking area.

### BRIEF DESCRIPTION OF DRAWINGS

Objects, features and advantages of the present disclosure will become apparent from the following detailed description made with reference to the accompanying drawings. In the drawings:

FIG. 1 is a diagram showing a configuration of an automated valet parking lot;

FIG. 2 is a block diagram showing a configuration of a control system and a vehicle;

FIG. 3 is a sequence diagram showing an entrance process executed by a control system and a vehicle;

FIG. 4 is a flowchart showing an entrance guidance process;

FIG. 5 is a flowchart showing a vehicle guidance process included in the entrance guidance process;

FIG. 6 is a sequence diagram showing an exit process executed by a control system and a vehicle; and

FIG. 7 is a flowchart showing a modified example of entrance guidance process.

### DETAILED DESCRIPTION

After the inventor of the present disclosure performs detailed examination on the conventional parking assist, the following issues have been found. The control device guides the vehicle to an empty parking section when an empty parking section exists. When there is no empty parking section in a parking area, the control device controls the vehicle to wait outside of the parking area. Thus, the parking area is not fully utilized when guiding the vehicles to enter the parking lot.

One aspect of the present disclosure provides a technique for making effective use of a space in a parking area when guiding the vehicles to enter parking sections in the parking area.

According to an aspect of the present disclosure, a control device, which is used in an automated valet parking lot, includes: an availability determination unit determining an availability of a parking section included in a parking area, the parking area being defined as an area in which an autonomous driving of a vehicle is executed according to a guidance of the control device within the automated valet parking lot; and a vehicle guidance unit guiding an entrance vehicle to the parking section according to the availability of the parking section determined by the availability determination unit, the entrance vehicle corresponding to the vehicle that requests an entrance to the parking section. When the availability determination unit determines that the parking section is unavailable, the vehicle guidance unit guides the entrance vehicle to a passage included in the parking area.

According to the above configuration, the space in the parking area can be used more effectively when guiding the vehicles to enter parking sections in the parking area.

Exemplary embodiments of the present disclosure will be described below with reference to the drawings.

### 1. Configuration

(1-1. Configuration of Automated Valet Parking Lot)

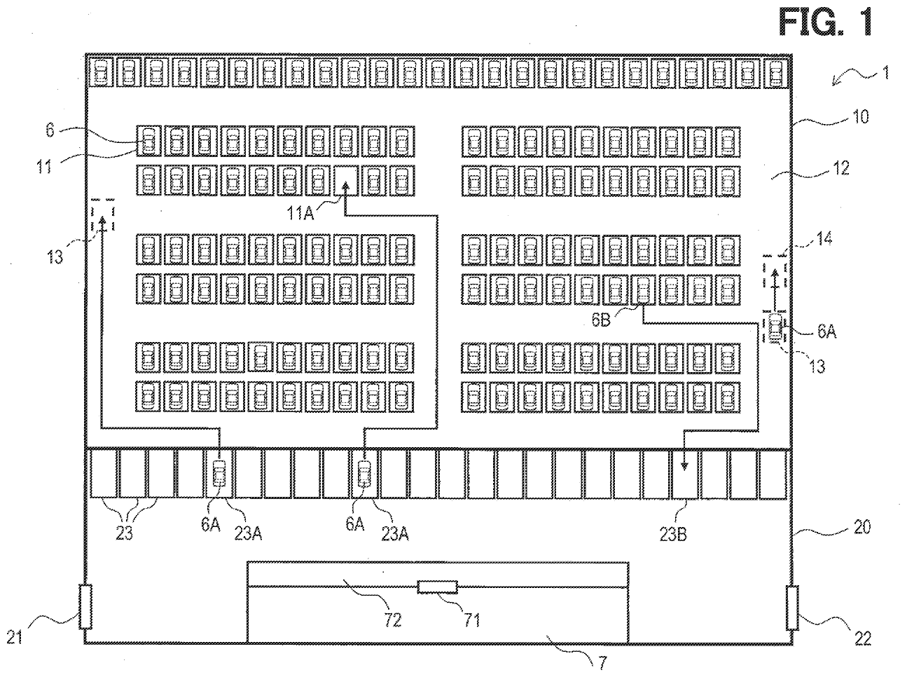

As shown in FIG. 1, an automated valet parking lot 1 includes a parking area 10 and an entrance and exit area 20. The parking area 10 is adjacent to the entrance and exit area 20.

In the automated valet parking lot 1, the parking area 10 is an area in which an autonomous driving is performed according to a guidance of a control device 30, which will be described later. The parking area 10 includes parking sections 11 and passages 12. The parking section 11 is an area for parking a vehicle 6. The passage 12 is an area that can be selected as a guidance route by the control device 30 when the vehicle 6 enters the parking section 11 and exits from the parking section 11.

The entrance and exit area 20 is an area through which the vehicle 6 passes when the vehicle moves from the outside of the automated valet parking lot 1 to the parking area 10 or when the vehicle moves from the parking area 10 to the outside of the automated valet parking lot 1. The entrance and exit area 20 includes a parking lot entrance 21 and a parking lot exit 22, each of which connects an inside area of the automated valet parking lot 1 with an outside area of the automated valet parking lot 1. The entrance and exit area 20 includes multiple vehicle rooms 23.

The vehicle room 23 is an area where a user of the automated valet parking lot 1 (hereinafter referred to as a user) exits from the vehicle 6 before the autonomous driving of the vehicle is performed in the parking area 10. Furthermore, the vehicle room 23 is also an area where the user gets on the vehicle 6 after the autonomous driving of the vehicle is performed in the parking area 10. The vehicle room 23 has a size capable of accommodating one vehicle 6. In the entrance and exit area 20, multiple vehicle rooms 23 are arranged side by side, and the multiple vehicle rooms are adjacent to the parking area 10. The vehicle room 23 corresponds to an alighting area, and also corresponds to a boarding area. A user corresponds to an occupant of the vehicle 6.

A vehicle 6 heading for the parking area 10 from the outside of the automated valet parking lot 1 can enter the parking area 10 from the outside of the automated valet parking lot 1 through the parking lot entrance 21. Then, the vehicle 6 can enter one of the vehicle rooms 23 and stop. After the user exits from the vehicle in the vehicle room 23, the vehicle 6 can move to the parking area 10.

The vehicle 6 heading from the parking area 10 to the outside of the automated valet parking lot 1 moves to one of the vehicle rooms 23 in the entrance and exit area 20 from the parking area 10 and stops at the entrance and exit area 20. After the user gets on the vehicle 6 in the vehicle room 23, the vehicle 6 may move to the parking lot exit 22 and proceed outside of the automated valet parking lot 1 through the parking lot exit 22.

The entrance and exit area 20 is adjacent to a facility 7. The facility 7 is, for example, a store, an office, a house, or a station. A doorway 71 of the facility 7 and the entrance and exit area 20 are connected via, for example, a pedestrian-only area 72.

(1-2. Control System)

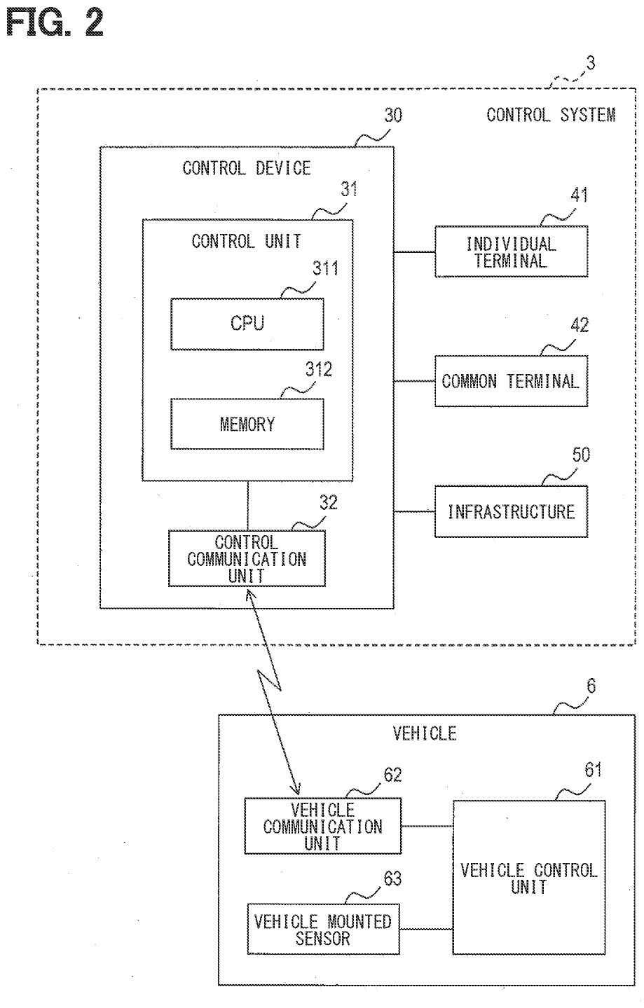

A control system 3 shown in FIG. 2 is a system used in the automated valet parking lot 1. The control system 3 includes a control device 30, multiple individual terminals 41, a common terminal 42, and an infrastructure 50.

The control device 30 includes a control unit 31 and a control communication unit 32.

The control unit 31 includes a microcomputer. The microcomputer may include a CPU 311 and a semiconductor memory (hereinafter, referred to as a memory) 312, such as a RAM or a ROM. Each function of the control unit 31 is implemented when a program, which is stored in a non-transitory tangible storage medium, is executed by the CPU 311. In this example, the memory 312 corresponds to the non-transitory tangible storage medium in which the program is stored. By executing the program, a method corresponding to the program is executed. The control unit 31 may include one microcomputer or multiple microcomputers.

The control communication unit 32 performs a wireless communication with the vehicle 6.

Each of the multiple individual terminals 41 is associated with one vehicle room 23. Each individual terminal 41 is installed close to the corresponding vehicle room 23. The individual terminal 41 accepts the user's operation. Examples of the user's operation may include an entrance request operation and user identification information input. The individual terminal 41 displays information to the user.

The common terminal 42 is positioned in the entrance and exit area 20. The common terminal 42 accepts user's operations. Examples of the user's operation may include an exit request operation and user identification information input. The common terminal 42 displays information to the user.

The infrastructure 50 includes multiple sensors for detecting information indicating a situation inside the automated valet parking lot 1 (hereinafter referred to as parking lot inside information). Examples of the sensors include cameras and LiDAR. For example, the multiple sensors may be attached to a ceiling or wall surface of the automated valet parking lot 1. The multiple sensors can also detect information indicating a situation inside the vehicle room 23 as the parking lot inside information. The infrastructure 50 supplies the detected parking lot inside information to the control device 30. The infrastructure 50 includes a device for guiding the vehicle 6. As a device for guiding the vehicle 6, for example, a display device for displaying a traveling direction of the vehicle 6, or the like can be used.

The vehicle 6 has an automated valet parking function. The automated valet parking function includes autonomous driving function and automatic parking function. The vehicle 6 includes a vehicle control unit 61, a vehicle communication unit 62 and a vehicle mounted sensor 63.

The vehicle control unit 61 controls each unit of the vehicle 6. The automated valet parking function is implemented by a control operation performed by the vehicle control unit 61.

The vehicle communication unit 62 performs a wireless communication with the control device 30. By the communication, the vehicle 6 can acquire map information and the guidance route from the control device 30. The vehicle 6 uses the map information and the guidance route acquired from the control device 30, for example, when performing the autonomous driving.

The vehicle mounted sensor 63 acquires peripheral information representing a peripheral situation of the vehicle 6. For example, the peripheral information may include information about positions of obstacles existing around the vehicle 6, or the like. The vehicle mounted sensor 63 may be a camera, a LiDAR, a millimeter wave sensor, or the like. The vehicle 6 may have one vehicle mounted sensor 63, or may have multiple vehicle mounted sensors 63. The vehicle 6 may use the acquired peripheral information when estimating an own position. Specifically, the vehicle 6 estimates the own position based on the peripheral information acquired using the vehicle mounted sensor 63 and the map information acquired from the control device 30.

### 2. Process

The following will describe an entrance and exit related process executed by the control system 3 and the vehicle 6. In this process, when the control device 30 determines an empty parking section 11 exists, the control device 30 guides an entrance vehicle 6A, which entered the parking lot, from the vehicle room 23 to the empty parking section 11. The control device also guides a vehicle 6B, which exits from the parking area 10, to the vehicle room 23.

(2-1. Entrance Related Process)

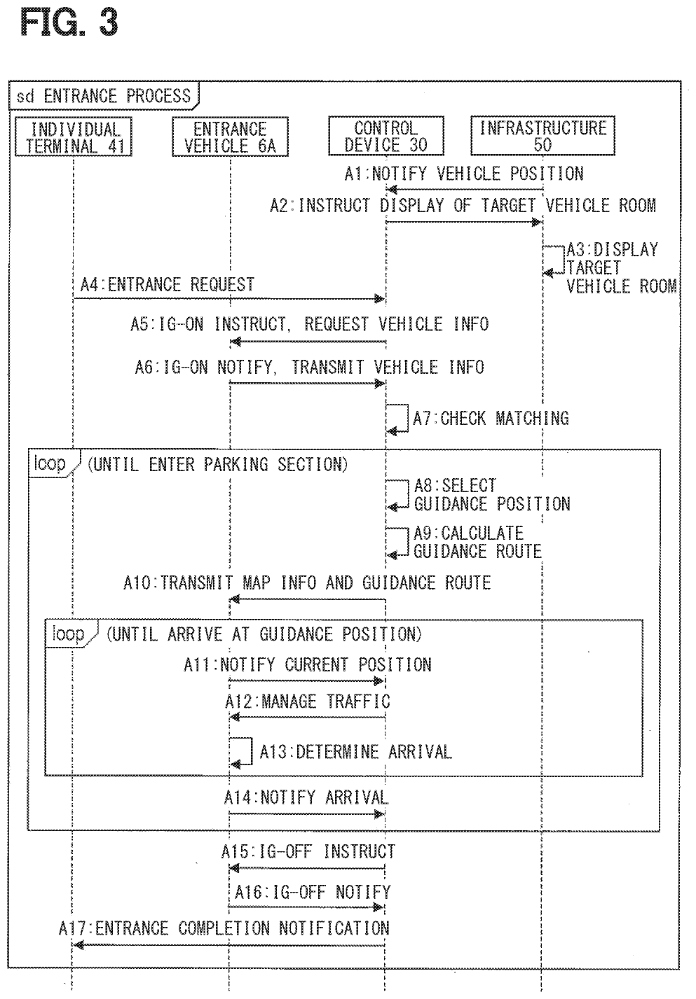

The following will describe an entrance related process executed by the control system 3 and the vehicle 6 with reference to FIG. 3.

In A1, the infrastructure 50 detects an arrival of the vehicle 6 to the automated valet parking lot 1. For example, the arrival of the vehicle 6 may be determined when the vehicle 6 passes through the parking lot entrance 21. The infrastructure 50 notifies, to the control device 30, the position of vehicle 6.

In A2, the control device 30 instructs the infrastructure 50 to notify the user of a position where the autonomous driving can be started. The autonomous driving refers to autonomous driving using an automated valet parking function. The position at which the autonomous driving can be started is one of the vehicle rooms 23. The control device 30 instructs the infrastructure 50 to display, for example, one of the vehicle rooms 23.

In A3, the infrastructure 50 notifies the user of the position where the autonomous driving can be started. The infrastructure 50 displays, for example, one of the vehicle rooms 23. Specifically, the display device of the infrastructure 50 displays, for example, an identification number of the vehicle room 23 into which the vehicle 6 is required to enter. Hereinafter, the vehicle room 23 related to the display is referred to as an entrance room 23A.

After the vehicle 6 enters the entrance room 23A and the user gets off in the entrance room 23A, the user inputs information to the individual terminal 41. The information includes an entrance request, which requests entrance of the vehicle 6 into the parking section 11. Hereinafter, the vehicle 6 that is the target of the entrance request and has not completed parking in the parking section 11 is referred to as an entrance vehicle 6A. The smartphone may be configured to enable the user input the information to the smartphone. The smartphone is a terminal carried by the user.

In A4, the individual terminal 41 transmits, to the control device 30, the entrance request input by the user. Alternatively, the smartphone may transmit the entrance request input by the user to the control device 30.

In A5, the control device 30 transmits an ignition-on instruction to the entrance vehicle 6A. The ignition-on instruction is an instruction for turning on an ignition of the vehicle. The entrance vehicle 6A turns on the ignition in response to the ignition-on instruction. The control device 30 requires the entrance vehicle 6A to transmit vehicle information. For example, the vehicle information includes an ego position of the entrance vehicle 6A, a size of the entrance vehicle 6A, a type of automated valet parking function installed to the entrance vehicle 6A, or the like. The ego position of the entrance vehicle 6A is the position of the entrance vehicle 6A estimated by the entrance vehicle 6A.

In A6, the entrance vehicle 6 transmits an ignition-on notification and vehicle information to the control device 30. The ignition-on notification indicates that the ignition of the vehicle is turned on.

In A7, the control device 30 checks matching between the automated valet parking lot 1 and the entrance vehicle 6A based on the information received in A6.

In A7, when the matching between the automated valet parking lot 1 and the entrance vehicle 6A is confirmed, the process repeatedly executes A8 to A14 until the entrance vehicle 6A arrives at the empty parking section 11.

In A8, the control device 30 selects a guidance position for the entrance vehicle 6A. The guidance position is a position in the parking area 10 where the control device 30 guides the entrance vehicle 6A.

In A9, the control device 30 calculates a guidance route for the entrance vehicle 6A to the guidance position selected in A8.

In A10, the control device 30 transmits, to the entrance vehicle 6A, the parking lot map and the guidance route calculated in A9. The parking lot map indicates map information of the automated valet parking lot 1. The entrance vehicle 6A receives the parking lot map.

The process repeatedly executes A11 to A13 until the entrance vehicle 6A arrives at the guidance position.

In A11, the entrance vehicle 6A travels toward the guidance position and transmits the current position of the entrance vehicle 6A to the control device 30. The current position of the entrance vehicle 6A is the position of the entrance vehicle 6A currently estimated by the entrance vehicle 6A.

In A12, the control device 30 manages traffic based on the current position of the entrance vehicle 6A received in A11. The control device 30 transmits instructions for stopping, starting, and rerouting to the entrance vehicle 6A as necessary. The entrance vehicle 6A stops, starts, and reroutes in response to the instructions.

In A13, the entrance vehicle 6A determines whether the entrance vehicle 6A has arrived at the guidance position. When the entrance vehicle 6A has not yet arrived at the guidance position, the process returns to A11. When the entrance vehicle 6A has arrived at the guidance position, the process proceeds to A14.

In A14, the entrance vehicle 6A transmits an arrival notification to the control device 30. The arrival notification indicates that the entrance vehicle 6A has arrived at the guidance position.

When the arrival notification is transmitted, in A14, from the entrance vehicle 6A before the entrance vehicle 6A enters the parking section 11, the process returns to A8. When the arrival notification is transmitted, in A14, from the entrance vehicle 6A after the entrance vehicle 6A enters the parking section 11, the process proceeds to A15.

In A15, the control device 30 transmits an ignition-off instruction to the entrance vehicle 6A. The ignition-off instruction is an instruction for turning off the ignition of the vehicle. The entrance vehicle 6A turns off the ignition in response to the ignition-off instruction.

In A16, the entrance vehicle 6 transmits an ignition-off notification to the control device 30. The ignition-off notification indicates that the ignition of the vehicle is turned off.

In A17, the control device 30 notifies the individual terminal 41 of completion of entrance. The entrance completion notification indicates that entrance of the vehicle 6A into the parking section 11 is completed. The control device 30 may notify the smartphone of the entrance completion. When the entrance completion notification is transmitted from the control device 30, the process is ended.

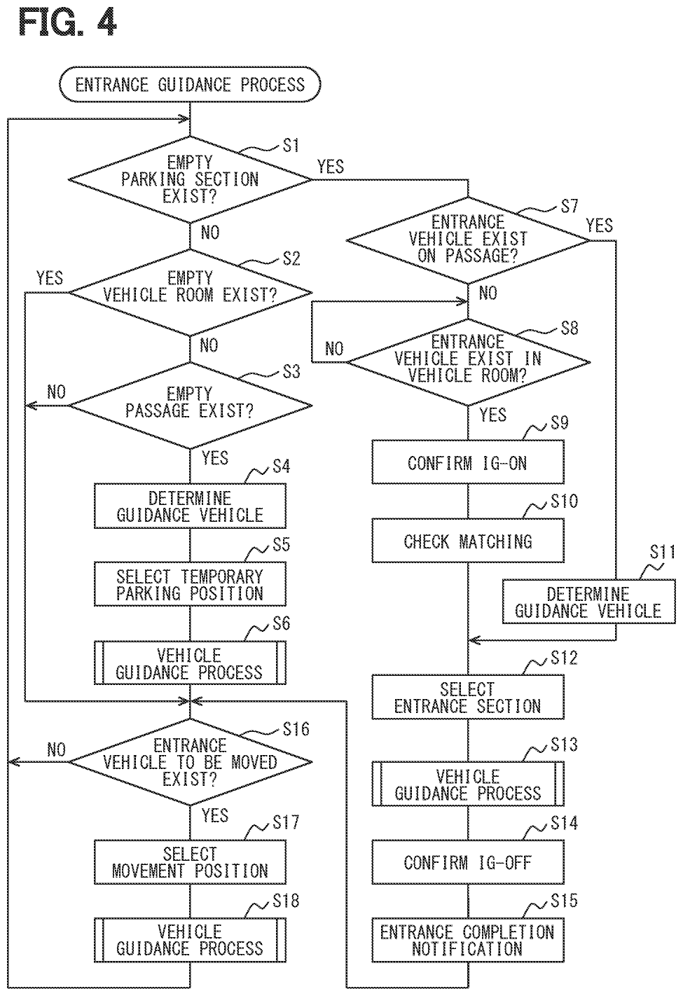

The following will describe an entrance guidance process executed by the control device 30 in A4 to A17 with reference to FIG. 4.

In S1, the control device 30 determines whether an empty parking section 11 exists in the parking lot t based on the parking lot inside information detected by the infrastructure 50. In the present embodiment, when vehicles 6 are parked in all of the parking sections 11 of the automated valet parking lot 1, the control device 30 determines that no empty parking section 11 exists. Alternatively, within the automated valet parking lot 1, when one or more of the parking sections 11 are empty without vehicles being parked but the one or more parking sections 11 have already set as guidance positions of other entrance vehicle 6A, the control device 30 may determine that no empty parking section 11 exists. When determining no empty parking section 11 exists, the process proceeds to S2. When determining an empty parking section 11 exists, the process proceeds to S7.

In S2, the control device 30 determines whether an empty vehicle room 23 exists in the parking lot t based on the parking lot inside information detected by the infrastructure 50. In the present embodiment, when all of the vehicle rooms 23 of the automated valet parking lot 1 are occupied by the entrance vehicles 6A or exit vehicles 6B, the control device 30 determines that no empty vehicle room 23 exists. The exit vehicle 6B refers to the vehicle 6, which is a target of exit request. That is, the exit vehicle indicates the vehicle which requests an exit from the parking area 10. When determining no empty vehicle room 23 exists, the process proceeds to S3. When determining an empty vehicle room 23 exists, the process proceeds to S16.

The control device 30 does not immediately guide the entrance vehicle 6A in the vehicle room 23 when determining existence of an empty vehicle room 23 in S2. That is, the control device 30 controls the entrance vehicle 6A in the vehicle room 23 to wait in the vehicle room 23. At this time, the control device 30 transmits, to the individual terminal 41 or the smartphone, an entrance wait notification indicating the parking of entrance vehicle 6A is in waiting state. By the entrance wait notification, the user can understand that the entrance procedure for the entrance vehicle 6A has been completed normally, although the entrance vehicle 6A is still parked in the vehicle room 23.

In S3, the control device 30 determines whether an empty passage 12 exists in the parking lot t based on the parking lot inside information detected by the infrastructure 50. In the present embodiment, the control device 30 determines that no empty passage 12 exists when the number of entrance vehicles 6A parked on all of the passages 12 is equal to or greater than a predetermined number. When determining an empty passage 12 exists, the process proceeds to S4. When determining no empty passage 12 exists, the process proceeds to S16.

In S4, the control device 30 determines one of the entrance vehicles 6A stopped in the vehicle rooms 23 as a guidance vehicle to be guided to the passage 12. After guided to the passage, the guidance vehicle 6A waits on the passage 12. After guiding the entrance vehicle 6A, which is determined as the guidance vehicle, to the passage 12, the control device 30 controls the entrance vehicle 6A to wait on the passage 12 until a parking section 11 becomes empty. The entrance vehicle 6A moved to the passage 12 and kept in standby state on the passage 12 is also referred to as a temporary parking. The mode of temporary parking is not limited to stopping the vehicle on the passage 12. For example, low speed traveling on the passage 12 may also set as one mode of the temporary parking. In the present embodiment, the temporary parking is defined as selecting a temporary parking position 13 on the passage 12 for temporary parking purpose, moving the entrance vehicle 6A to the temporary parking position 13, and then stopping the entrance vehicle 6A at the temporary parking position 13. As shown in FIG. 1, the temporary parking position 13 is a predetermined position on the passage 12 for temporarily stopping the entrance vehicle 6A until the parking section 11 becomes empty. In the present embodiment, in S4, the control device 30 determines the guidance vehicle, which is to be guided to the temporary parking position 13. Specifically, among all of the entrance vehicles 6A existing in the vehicle rooms 23, the control device 30 determines the entrance vehicle 6A, which has entered the vehicle room 23 at the earliest time, as the guidance vehicle that is to be guided to the temporary parking position 13. The temporary parking positions 13 shown in FIG. 1 are partial examples of all of the temporary parking positions 13 provided in the automated valet parking lot 1. In the automated valet parking lot 1, the temporary parking position 13 may be set in advance, or may be set by the control device 30 each time the temporary parking position is required. When setting multiple temporary parking positions 13, a parking direction may be set for each temporary parking position 13. For example, for each temporary parking position 13, the parking direction may be set to parallel to a longitudinal direction of the entrance vehicle when the entrance vehicle 6A travels along the passage 12. That is, the parking direction may be set parallel to a longitudinal direction of the passage.

In the present embodiment, when the process determines existence of the parking section 11 in S1, the control device 30 guides the entrance vehicle 6A to the parking section 11. When the process determines that no empty parking section 11 exists in S1 and determines that an empty vehicle room 23 exists in S2, the control device 30 controls the entrance vehicle 6A to wait in the vehicle room 23. When the process determines that no empty parking section 11 exists in S1, determines that no empty vehicle room 23 exists in S2, and determines that an empty passage 12 exists in S3, the control device 30 guides the entrance vehicle 6A to the empty passage 12. That is, the control device 30 selects the parking section 11, the vehicle room 23, and the passage 12 in described order as the parking position or temporary parking position of the entrance vehicle 6A.

In S5 of FIG. 4, the control device 30 selects the temporary parking position 13 as the guidance position of the entrance vehicle 6A, which is determined as the guidance vehicle in S4. Multiple temporary parking positions 13 provided in the automated valet parking lot 1 are assigned with priorities when being selected as the guidance positions. In S5, the control device 30 may select the temporary parking position 13 having the highest priority as the guidance position among multiple empty temporary parking positions 13. The process executed in S5 corresponds to the above-described process executed in A8.

The following will describe an example of priority of selecting one of the temporary parking positions 13 as the guidance position.

For example, the priority may be determined based on a straight linear distance or a distance along the route from the current position of the entrance vehicle 6A to the temporary parking position 13. Specifically, the highest priority may be set for the temporary parking position 13, which is closest to the current position of the entrance vehicle 6A.

Alternatively, a higher priority may be set to the temporary parking position 13, which is close to the parking section 11 that is scheduled to become empty state at an earlier time, based on the information of the exit reservation.

Alternatively, a higher priority may be set to the temporary parking position 11, which faces the parking section 11 where the vehicle 6 is scheduled to be parked for a predetermined period or longer, based on the information of the exit reservation. Since it is presumed that the vehicle 6 parked in the parking section 11 will not exit the parking section 11 until the time indicated by the exit reservation, even though the entrance vehicle 6A is temporarily parked in the moving direction of the parked vehicle 6, for example, in front direction of the parked vehicle 6, it is less likely to interrupt the parked vehicle 6.

Alternatively, in the parking area 10, a higher priority may be set to the temporary parking position 13 in an area that is less frequently selected as the guidance route for the entrance vehicle 6A or the exit vehicle 6B. The selection frequency as the guidance route in the parking area 10 may be set based on the actual setting history, or may be set in advance based on a shape of the parking section 11 and the passage 12 in the parking area 10. For example, for a region distant from the vehicle room 23 in the parking area 10, low selection frequency may be set. In other words, a higher priority may be set to the temporary parking position 13 in the region distant from the vehicle room 23 in the parking area 10.

In S6, the control device 30 executes a vehicle guidance process, which will be described later. In the vehicle guidance process, the control device 30 guides the entrance vehicle 6A to the guidance position. When the vehicle guidance process ends in S6, the entrance vehicle 6A guided by the control device 30 is located at the temporary parking position 13, which is set as the guidance position. Then, the entrance vehicle 6A waits at the temporary parking position 13 in the ignition-state until the parking section 11 becomes empty. The ignition-on state includes an idling stop state. When a predetermined duration has elapsed since the guidance of the entrance vehicle 6A to the temporary parking position 13 is completed, that is, when the waiting period of the entrance vehicle 6A at the temporary parking position 13 exceeds a predetermined period, the control device 30 transmits an ignition-off instruction to the entrance vehicle 6A. The entrance vehicle 6A turns off the ignition in response to the ignition-off instruction, and transmits an ignition-off notification to the control device 30. After executing S6, the process proceeds to S16.

In S7, the control device 30 determines whether an entrance vehicle 6A exists on the passage 12. In the present embodiment, the control device 30 determines whether an entrance vehicle 6A waits at the temporary parking position 13, which is set as a position on the passage 12. When determining that no entrance vehicle 6A exists on the passage 12, the process proceeds to S8. When determining an entrance vehicle 6A exists on the passage 12, the process proceeds to S11.

In S8, the control device 30 determines whether an entrance vehicle 6A exists in the vehicle room 23. In the present embodiment, after receiving an entrance request from the individual terminal 41, when the entrance vehicle 6A, which is the transmission source of the entrance request, has not yet been guided into the parking area 10, the control device 30 determines that the entrance vehicle 6A exists in the vehicle room 23. When determining that no entrance vehicle 6A exists in the vehicle room 23, the process repeatedly executes S8. When determining an entrance vehicle 6A exists in the vehicle room 23, the process proceeds to S9. The process executed in S8 corresponds to the above-described process executed in A4.

In S9, the control device 30 determines whether the ignition of entrance vehicle 6A, which is determined to be existing in the vehicle room 23 in S8, is in on state by transmitting the ignition-on instruction and confirming reception of the ignition-on notification. The process executed in S9 corresponds to the above-described process executed in A5 and A6.

In the present embodiment, as described above, the process has determined, in S1, that an empty parking section 11 exists, the control device 30 does not determine whether an empty parking section 11 exists when transmitting the ignition-on instruction to the entrance vehicle in S9. However, even though the process has determined that an empty parking section 11 exists in S1, the control device 30 may determine again whether an empty parking section 11 exists when the entrance vehicle 6A is determined to be existing in the vehicle room 23 in S8.

In S10, the control device 30 checks matching between the automated valet parking lot 1 and the entrance vehicle 6A, which is determined to be existing in the vehicle room 23 in S8. The process executed in S10 corresponds to the above-described process executed in A7. After executing S10, the process proceeds to S12.

In S11, the control device 30 determines the entrance vehicles 6A existing on the passage 12 as a guidance vehicle to be guided to the parking section 11. In the present embodiment, the control device 30 records a distance traveled within the parking area 10 for each entrance vehicle 6A. When multiple entrance vehicles 6A exist on the passage 12, the control device 30 determines the priority of entrance to the parking section 11 for the multiple entrance vehicles 6A with consideration of respective travel distances of the entrance vehicles 6A. In the present embodiment, the entrance vehicle 6A may be guided from the vehicle room 23 to the temporary parking position 13 set on the passage 12, and then may be guided again from the temporary parking position 13 to a movement position 14 on the passage 12. The movement position on passage 12 is different from the temporary parking position on the passage 12, where the vehicle firstly guided to. In this case, the travel distance of the entrance vehicle in the parking area 10 is a sum of the travel distance from the vehicle room 23 to the temporary parking position 13 and the travel distance from the temporary parking position 13 to the movement position 14. For example, for the multiple entrance vehicles 6A existing on the passage 12, the control device 30 compares the respective travel distances of the entrance vehicles 6A within the parking area 10, and may assign the highest priority to the entrance vehicle 6A having the longest travel distance. Then, the control device 30 determines, as the guidance vehicle, the entrance vehicle 6A having the highest entrance priority to the parking section 11. Alternatively, the control device 30 may determine the guidance vehicle so that the traveling distances of the entrance vehicles 6A within the parking area 10 are approximately the same for the entrance vehicles 6A existing on the passage 12. When the entrance vehicle 6A on the passage 12 determined as the guidance vehicle is in the ignition-off state while S6 is being executed, the control device 30 confirms ignition-on of the entrance vehicle 6A by transmitting the ignition-on instruction and confirming reception of the ignition-on notification. After executing S11, the process proceeds to S12.

In S12, regarding the entrance vehicle 6A in the vehicle room 23 for which matching with the automated valet parking lot 1 is confirmed in S10 or regarding the entrance vehicle 6A existing on the passage 12 determined as the guidance vehicle in S11, the control device 30 selects one of the empty parking sections 11 as the guidance position. The parking section 11 selected in S12 is also referred to as an entrance section 11A. The process executed in S12 corresponds to the above-described process executed in A8.

In S13, the control device 30 executes a vehicle guidance process, which will be described later. As described in S7, S8, and S11 above, when a parking section 11 becomes empty, the control device 30 guides, to the parking section 11, the entrance vehicle 6A existing on the passage 12 first, and then guides the entrance vehicle 6A in the vehicle room 23.

When the vehicle guidance process ends in S13, the entrance vehicle 6A guided by the control device 30 is located at the entrance section 11A, which is set as the guidance position. That is, the entrance vehicle 6A guided by the control device 30 enters the entrance section 11A.

In S14, the control device 30 determines whether the ignition of entrance vehicle 6A, which has entered the entrance section 11A in S13, is in off state by transmitting the ignition-off instruction and confirming reception of the ignition-off notification. The process executed in S14 corresponds to the above-described process executed in A15 and A16.

In S15, the control device 30 transmits, to the individual terminal 41, an entrance completion notification after the ignition-off state of the entrance vehicle 6A is confirmed in S14. The process executed in S15 corresponds to the above-described process executed in A17. After executing S15, the process proceeds to S16.

In S16, the control device 30 determines whether an entrance vehicle 6A existing on the passage 12 needs to be moved (hereinafter referred to as an entrance vehicle 6A that needs to be moved). In the present embodiment, the control device 30 determines an existence of entrance vehicle 6A that needs to be moved when an exit vehicle 6B exists and the entrance vehicle 6A is located on an exit route of the exit vehicle 6B. When determining the existence of entrance vehicle 6A that needs to be moved, the entrance vehicle 6A that needs to be moved may correspond to the entrance vehicle 6A existing on an exit route. For example, when moving the entrance vehicle 6A existing on the exit route to a target position distant from the exit route and another entrance vehicle 6A is located at the target position, another entrance vehicle 6A also needs to be moved. That is, another entrance vehicle 6A also corresponds to an entrance vehicle that needs to be moved. When determining that an entrance vehicle 6A that needs to be moved exists in S16, the process proceeds to S17. When determining that no entrance vehicle 6A that needs to be moved exists in S16, the process returns to S1.

In S17, the control device 30 selects, as the guidance position, a movement position 14 for the entrance vehicle 6A that needs to be moved, which is determined to be existing in S16. As shown in FIG. 1, the movement position 14 is a predetermined position on the path 12 different from the temporary parking position 13 where the entrance vehicle 6A that needs to be moved exists. The process executed in S17 corresponds to the above-described process executed in A8.

In S18 shown in FIG. 4, the control device 30 executes a vehicle guidance process, which will be described later. When the vehicle guidance process ends in S18, the entrance vehicle 6A guided by the control device 30 is located at the movement position 14, which is set as the guidance position. After executing S18, the process returns to S1.

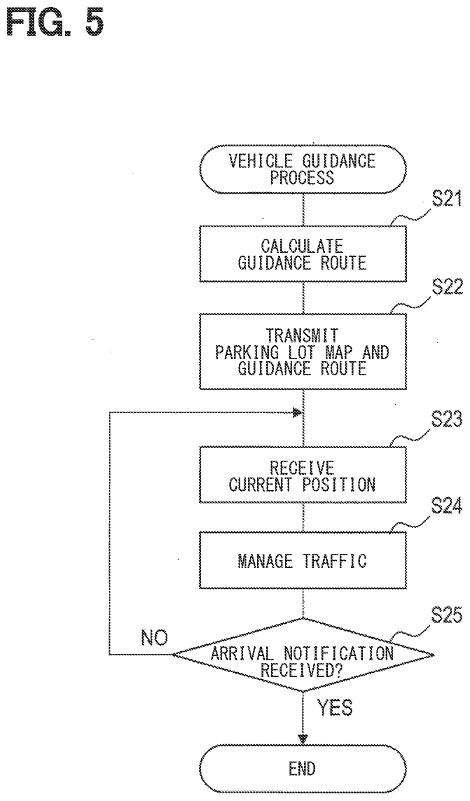

The following will describe the entrance guidance process with reference to FIG. 5.

In 21, the control device 30 calculates a guidance route for the entrance vehicle 6A. The process executed in S21 corresponds to the above-described process executed in A9.

In S22, the control device 30 transmits, to the entrance vehicle 6A, the parking lot map and the guidance route calculated in S21. The process executed in S22 corresponds to the above-described process executed in A10.

In S23, the control device 30 receives the current position of the entrance vehicle 6A from the entrance vehicle 6A. The process executed in S23 corresponds to the above-described process executed in A11.

In S24, the control device 30 manages traffic. The process executed in S24 corresponds to the above-described process executed in A12.

In S25, the control device 30 determines whether an arrival notification, which is transmitted from the entrance vehicle 6A, is received. The process executed in S25 corresponds to the above-described process executed in A14. When the arrival notification is not received, the process returns to S23. When the arrival notification is received, the process is ended.

(2-2. Exit Related Process)

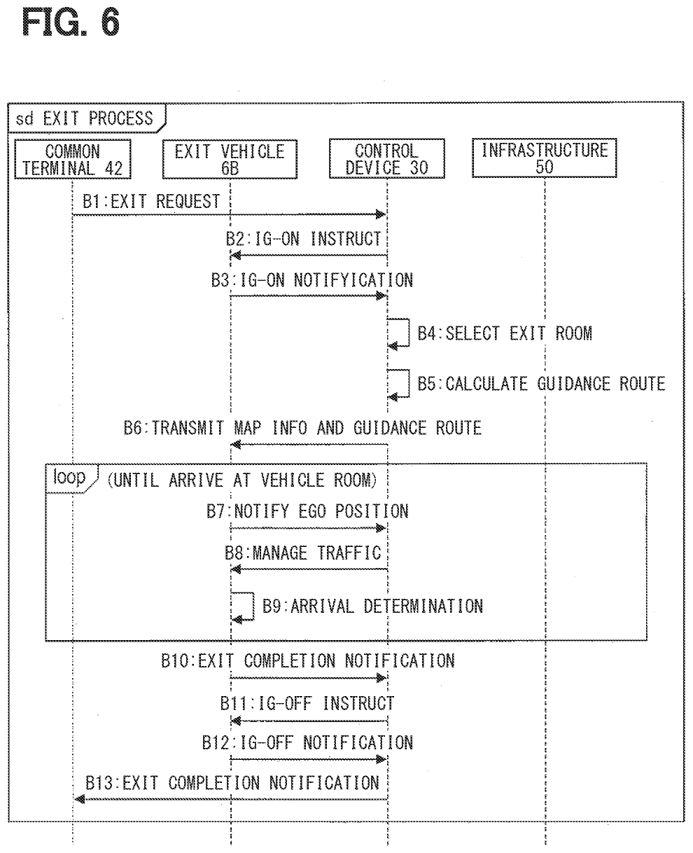

The following will describe an exit related process executed by the control system 3 and the vehicle 6 with reference to FIG. 6.

First, the user inputs information to the common terminal 42. The information includes an exit request for requesting exit of the vehicle 6 from the parking area 10. As described above, the vehicle 6, which is the target of the exit request, is referred to as an exit vehicle 6B. The smartphone may be configured to enable the user input the information to the smartphone.

In B1, the common terminal 42 transmits, to the control device 30, the exit request input by the user. Alternatively, the smartphone may transmit the exit request input by the user to the control device 30.

In B2, the control device 30 transmits an ignition-on instruction to the exit vehicle 6B. The exit vehicle 6B turns on the ignition in response to the ignition-on instruction.

In B3, the exit vehicle 6B transmits an ignition-on notification to the control device 30.

In B4, the control device 30 selects one of the vehicle rooms 23. Hereinafter, the vehicle room 23 selected in B4 is referred to as an exit room 23B.

In B5, the control device 30 calculates a guidance route of the exit vehicle 6B to the exit room 23B.

In B6, the control device 30 transmits, to the exit vehicle 6B, the parking lot map and the guidance route calculated in B5. The exit vehicle 6B receives the parking lot map.

The process repeatedly executes B7 to B9 until the exit vehicle 6B arrives at the exit room 23B.

In B7, the exit vehicle 6B travels toward the exit room 23B, and transmits the current position of the exit vehicle 6B to the control device 30.

In B8, the control device 30 manages traffic based on the current position of the exit vehicle 6B, which is received in B7. The control device 30 transmits instructions for stopping, starting, and rerouting to the exit vehicle 6B as necessary. The exit vehicle 6B stops, starts, and reroutes in response to the instructions.

In B9, the exit vehicle 6B determines whether the exit vehicle 6B has arrived at the exit room 23B. When the exit vehicle 6B has not yet arrived at the exit room 23B, the process returns to B7. When the exit vehicle 6B arrives at the exit room 23B, the process proceeds to B10.

In B10, the exit vehicle 6B transmits an exit completion notification to the control device 30. The exit completion notification indicates that the exit vehicle 6B has arrived at the exit room 23B, that is, exit from the parking area 10 is completed.

In B11, the control device 30 transmits an ignition-off instruction to the exit vehicle 6B. The exit vehicle 6B turns off the ignition in response to the ignition-off instruction.

In B12, the exit vehicle 6B transmits an ignition-off notification to the control device 30.

In B13, the control device 30 transmits an exit completion notification to the common terminal 42. The control device 30 may transmit the exit completion notification to the smartphone. When the exit completion notification is transmitted from the control device 30, the process is ended.

### 3. Effects

The above-described embodiment provides the following effects.

(3a) The control device 30 is configured to guide the entrance vehicle 6A to the passage 12 when an empty parking section 11 does not exist.

According to this configuration, the passage 12 in the parking area 10 can be used more effectively when parking the entrance vehicle 6A in the parking section 11. That is, the space in the parking area 10 can be used more effectively. Thus, the parking area 10 can accommodate more entrance vehicles 6A.

(3b) After guiding the entrance vehicle 6A to stop on the passage 12, the control device 30 guides the entrance vehicle 6A, which is parked on the passage 12, to the parking section 11 in response to determining an existence of empty parking section 11.

According to the above configuration, the number of entrance vehicles 6A stopped on the passage 12 can be reduced. Therefore, the entrance vehicle 6A guided to the parking section 11 and the exit vehicle 6B can easily perform the autonomous driving using the automated valet parking function.

In the present embodiment, the control device 30 guides the entrance vehicle 6A to the temporary parking position 13 set on the passage 12, and controls the entrance vehicle 6A to wait at the temporary parking position 13. In response to determining existence of an empty parking section 11, the entrance vehicle 6A, which waits at the temporary parking position 13, is guided to the empty parking section 11.

According to the above configuration, it is possible to reduce the movement distance of the entrance vehicle 6A, which is temporarily parked on the passage 12. Thus, the automated valet parking lot 1 can be operated more smoothly with improved efficiency.

(3c) The control device 30 is configured to determine the guidance priority to the parking section 11 based on the travel distance of the entrance vehicle in the parking area 10 when multiple entrance vehicles 6A are parked on the passage 12.

According to the above configuration, within the parking area 10, it is possible to suppress unevenness in the travel distances of the entrance vehicles 6A, which exist on the passage 12.

(3d) When the process determines that no empty parking section 11 exists and determines that an empty vehicle room 23 exists, the control device 30 controls the entrance vehicle 6A to wait in the vehicle room 23.

According to the above configuration, the entrance vehicle 6A may be kept in the vehicle room 23 for a longer duration without guiding the entrance vehicle 6A to the passage 12. Thus, the number of entrance vehicles 6A on the passage 12 can be suppressed. Therefore, the entrance vehicle 6A guided to the parking section 11 and the exit vehicle 6B can easily perform the autonomous driving using the automated valet parking function.

(3e) When the process determines that no empty parking section 11 exists and determines that no empty vehicle room 23 exists, the control device 30 guides the entrance vehicle 6A existing in the vehicle room 23 to the passage 12.

According to the above configuration, the entrance vehicle 6A newly arriving at the automated valet parking lot 1 can smoothly enter the vehicle room 23.

(3f) The control device 30 guides the entrance vehicle 6A stopped on the passage 12 to a different position on the passage 12 when the exit vehicle 6B exists and the entrance vehicle 6A exists on the exit route of the exit vehicle 6B in order to secure the exit route.

According to the above configuration, the control device 30 can select the exit route for the exit vehicle 6B regardless of the position of the entrance vehicle 6A on the passage 12. Therefore, when guiding the entrance vehicle 6A to the passage 12, the control device 30 does not have to consider the exit route. Therefore, it is possible to reduce restriction when setting the guidance position of the entrance vehicle 6A on the passage 12, and more entrance vehicles 6A can be guided to the passage 12.

In the above embodiment, the process executed in S1 and S2 corresponds to an availability determination unit, the process executed in S5, S6, S11 to S13, S17, and S18 correspond to a vehicle guidance unit.

### 4. Other Embodiments

Although the embodiments of the present disclosure have been described above, the present disclosure is not limited to the embodiments described above, and various modifications can be made to implement the present disclosure.

(4a) In the above embodiment, the vehicle room 23 is an area where the user exits the vehicle 6 before the autonomous driving is to be performed in the parking area 10. After the autonomous driving is performed in the parking area 10, the user gest on the vehicle 6 in the vehicle room 23. For example, the vehicle rooms 23 may be separately prepared for get-on purpose and get-off purpose. Specifically, for example, a vehicle room 23 for get-off purpose may be prepared for the user to exit the vehicle 6 before the autonomous driving is performed in the parking area 10, and a vehicle room 23 for get-on purpose may be prepared for the user to enter the vehicle 6 after the autonomous driving is performed in the parking area 10. That is, the vehicle room 23 for get-off purpose and the vehicle room 23 for get-on purpose may be separately prepared for the user. In this case, for example, a ratio of the number of vehicle rooms 23 for get-off purpose to the number of vehicle rooms 23 for get-on purpose may be set to a variable value. For example, in a case where a ratio of the number of entrance vehicles 6A to the number of exit vehicles 6B varies depending on time slot, a ratio of the number of vehicle rooms 23 for get-off purpose may be increased during a time slot when the number of entrance vehicles 6A is increased. During a time slot when the number of exit vehicles 6B is increased, a ratio of the number of vehicle rooms 23 for get-on purpose may be increased. For example, when the automated valet parking lot 1 includes multiple vehicle rooms 23 for get-off purpose and multiple vehicle rooms 23 for get-on purpose, the control device 30 determines, in S2, no empty vehicle room 23 exists when the entrance vehicles 6A exist in all of the vehicle rooms 23.

(4b) In the above embodiment, when the process determines, in S2, that an empty vehicle room 23 exists, the control device 30 controls the entrance vehicle 6A to wait in the vehicle room 23 without guiding the entrance vehicle 6A to the passage 12. At this time, the control device 30 may transmit an ignition-off notification to the entrance vehicle 6A to turn off the ignition of the entrance vehicle 6A.

(4c) In the above embodiment, when the process determines, in S2, that an empty vehicle room 23 exists, the control device 30 does not guide the entrance vehicle 6A to the passage 12. Alternatively, the control device may guide the entrance vehicle 6A to the passage 12 regardless of existence of empty vehicle room 23. According to this configuration, the entrance vehicle 6A newly arriving at the automated valet parking lot 1 can smoothly enter the vehicle room 23.

(4d) In the above embodiment, when the process determines, in S3, that an empty passage 12 exists, the control device 30 guides the entrance vehicle 6A to the temporary parking position 13 set on the passage in S4 to S6 as described above. When another entrance vehicle 6A exists at another temporary parking position 13 on the passage 12, the control device 30 may align the parking direction of the entrance vehicle 6A with another entrance vehicle 6A along the passage 12. For example, the entrance vehicle 6A may be guided so that the longitudinal direction of the entrance vehicle 6A along the passage 12 is the same as the longitudinal direction of another entrance vehicle 6A. According to this configuration, it is possible to reduce a difference in the behaviors of the entrance vehicles 6A on a curve, or the like.

(4e) In the above embodiment, when the process determines, in S11, the vehicles to be guided to the parking section 11 in a case where multiple entrance vehicles 6A exist on the passage 12, the control device 30 determines the priority of entrance to the parking section 11 based on the travel distance of each entrance vehicle within the parking area 10. The priority of entrance to the parking section may be determined in a different method. For example, the control device 30 may determine the priority of entrance to the parking section 11 based on the distance from the current position of the entrance vehicle 6A to the parking section 11. Specifically, the control device 30 may give the highest priority to the entrance vehicle 6A having the shortest travel distance from the temporary parking position 13, which is the current position of entrance vehicle 6A, to the parking section 11. As another example, the control device 30 may determine the priority of entrance to the parking section 11 based on an entrance order of the entrance vehicles 6A, which have entered the vehicle rooms 23.

(4f) In the above embodiment, when the process determines, in S1, that an empty parking section 11 exists, the process proceeds to S7. When the control device 30 determines, in S7, that an entrance vehicle 6A exists on the passage 12, the control device 30 guides the entrance vehicle 6A on the passage 12 to the parking section 11 in S13 as described above. When the control device 30 determines, in S7, that no entrance vehicle 6A exists on the passage 12, the control device guides the entrance vehicle 6A in the vehicle room 23 to the parking section 11 in S13. That is, the control device 30 preferentially guides the entrance vehicle 6A on the passage 12 to the parking section 11 compared with the entrance vehicle 6A in the vehicle room 23. Alternatively, the control device 30 may determine the priority for guiding to the parking section 11 based on the position of the entrance vehicle 6A.

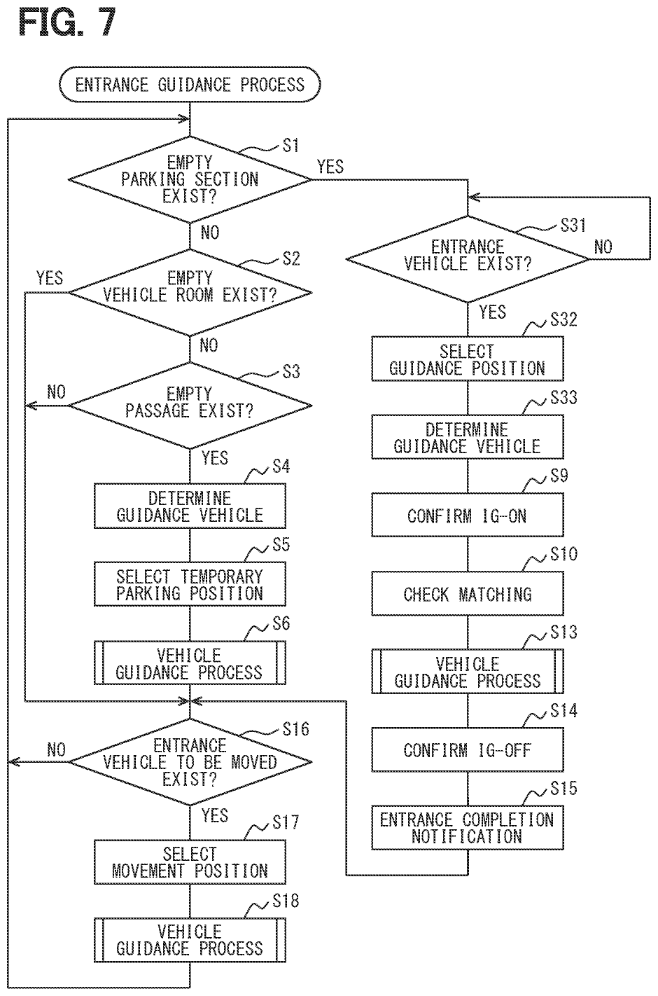

As an example, FIG. 7 shows a modification of the entrance guidance process. In a process according to this modification, when the process determines, in S1, that an empty parking section 11 exists, the process proceeds to S31 instead of S7 shown in FIG. 4.

In S31, the control device 30 determines whether an entrance vehicle 6A exists. The entrance vehicle 6A includes the entrance vehicle 6A in the vehicle room 23 and the entrance vehicle 6A existing on the passage 12. When determining that no entrance vehicle 6A exists, the process repeatedly executes S31. When determining that an entrance vehicle 6A exists, the process proceeds to S32.

In S32, the control device 30 selects one of the empty parking sections 11 as the guidance position, similar to S12 described above.

In S33, the entrance vehicle 6A determined to be existing in S31 is set as the guidance vehicle to be guided to the parking section 11, which is selected as the guidance position in S32. When multiple entrance vehicles 6A exist, the control device 30 calculates, for each entrance vehicle 6A, the distance from the current position of the entrance vehicle 6A to the parking section 11 selected as the guidance position. Then, the control device 30 sets the entrance vehicle 6A having the shortest distance to the parking section 11 as the guidance vehicle. The distance from the current position of the entrance vehicle 6A to the parking section 11 selected as the guidance position may be a straight line distance or a travel distance along the guidance route. After executing S33, the process proceeds to S9.

The process executed from S9 is substantially the same as the process described in the first embodiment. However, when S10 is completed, the process directly proceeds to S13 instead of S12 as shown in FIG. 4.

As described above, when the control device 30 guides the entrance vehicle 6A, which has the shortest distance to the parking section 11 selected as the guidance position, to the parking section 11, a moving distance of the entrance vehicle 6A for entering the parking section 11 can be reduced compared with moving other entrance vehicle. Thus, the automated valet parking lot 1 can be operated more smoothly with improved efficiency.

The process executed in S13, S32, and S33 in the above-descried modification corresponds to a vehicle guidance unit.

(4g) As the entrance guidance process, the process according to the above embodiment shown in FIG. 4 and the process according to the modification (4f) together with FIG. 7 have been described. The control device 30 may be configured to be execute both of these two processes shown in FIG. 4 and FIG. 7. For example, the control device 30 may change the process to be executed according to the time slot.

(4h) In the above embodiment, the automated valet parking lot 1 includes multiple vehicle rooms 23 as the alighting. Alternatively, the alighting is not necessarily provided in the automated valet parking lot 1.

(4i) The automated valet parking lot 1 may further include a transport device. The transport device may be a device that can move with the vehicle 6 in lift-up state according to a guidance of the control device 30. In the above embodiment, when the matching between the automated valet parking lot 1 and the entrance vehicle 6A is confirmed in A7, the control device 30 controls the vehicle 6A to enter the parking section 11. For example, when the automated valet parking lot 1 is equipped with the transport device, the transport device may be used to move the entrance vehicle 6A to the parking section 11 when the matching between the automated valet parking lot 1 and the entrance vehicle 6A is not confirmed.

(4j) Multiple functions of one configuration element in the above embodiments may be implemented by multiple configuration elements, or a single function of one configuration element may be implemented by multiple configuration elements. A part of the configuration of the above embodiments may be omitted as appropriate. At least a part of the configuration in one embodiment may be added to or substituted for the configuration of another embodiment.

(4k) In addition to the above control device 30, the present disclosure can also be implemented in various forms, such as a control system 3 including the control device 30 as an element, a vehicle guidance program that controls a computer to function as the control unit 31 of the control device 30, a non-transitory tangible storage medium, such as a semiconductor memory in which the above-described program is recorded, and a vehicle guidance method.

What is claimed is:

1. A control device used in an automated valet parking lot, the control device comprising:
an availability determination unit determining an availability of a parking section included in a parking area, the parking area being defined as an area in which an autonomous driving of a vehicle is executed according to a guidance of the control device within the automated valet parking lot; and
a vehicle guidance unit guiding an entrance vehicle to the parking section according to the availability of the parking section determined by the availability determination unit, the entrance vehicle corresponding to the vehicle that requests an entrance to the parking section,
wherein, when the availability determination unit determines that the parking section is unavailable, the vehicle guidance unit guides the entrance vehicle to a passage included in the parking area.

2. The control device according to claim 1, wherein,
when the availability determination unit determines that the parking section is available, the vehicle guidance unit guides the entrance vehicle from an alighting area to the parking section, the alighting area being included in the automated valet parking lot for an occupant of the entrance vehicle to get off the entrance vehicle before an execution of the autonomous driving, and
the vehicle guidance unit guides an exit vehicle, which is the vehicle requesting an exit from the parking area, from the parking area to a boarding area, the boarding area being included in the automated valet parking lot for an occupant of the exit vehicle to get on the exit vehicle after the execution of the autonomous driving.

3. The control device according to claim 1, wherein,
when the availability determination unit determines that the parking section is available after the entrance vehicle is guided to the passage, the vehicle guidance unit guides the entrance vehicle existing on the passage to the parking section that is determined to be available.

4. The control device according to claim 3, wherein,
when multiple entrance vehicles exist on the passage, the vehicle guidance unit determines a priority of guidance to the parking section based on respective travel distances of the multiple entrance vehicles within the parking area.

5. The control device according to claim 4, wherein
the vehicle guidance unit records the travel distance of each entrance vehicle within the parking area, and
when the multiple entrance vehicles exist on the passage, the vehicle guidance unit determines one of the multiple entrance vehicles, which has a longest recorded travel distance within the parking area, as the entrance vehicle having a highest priority of guidance to the parking section.

6. The control device according to claim 3, wherein,
when the availability determination unit determines that the parking section is available after multiple entrance vehicles are guided to the passage and exist on the passage, the vehicle guidance unit guides, to the parking section, one of the multiple entrance vehicles, which has a shortest distance to the parking section.

7. The control device according to claim 1, wherein
the availability determination unit further determines an availability of an alighting area, the alighting area being included in the automated valet parking lot for an occupant of the entrance vehicle to get off the entrance vehicle before an execution of the autonomous driving, and
when the availability determination unit determines that the parking section is unavailable and the alighting area is available, the vehicle guidance unit controls the entrance vehicle existing in the alighting area to wait in the alighting area.

8. The control device according to claim 7, wherein,
when the availability determination unit determines that the parking section is unavailable and the alighting area is unavailable, the vehicle guidance unit guides the entrance vehicle existing in the alighting area to the passage.

9. The control device according to claim 1, wherein,
when an exit vehicle, which is the vehicle requesting an exit from the parking area, exists and the entrance vehicle exists on an exit route of the exit vehicle, the vehicle guidance unit secures the exit route of the exit vehicle by guiding the entrance vehicle existing on the exit route to a different position on the passage.

10. A vehicle guidance method executed by at least one processor of a control device used in an automated valet parking lot, the vehicle guidance method comprising:
determining an availability of a parking section included in a parking area, the parking area being defined as an area in which an autonomous driving of a vehicle is executed according to a guidance of the control device within the automated valet parking lot;
guiding an entrance vehicle to the parking section according to the determined availability of the parking section, the entrance vehicle corresponding to the vehicle that requests an entrance to the parking section; and
in response to determining that the parking section is unavailable, guiding the entrance vehicle to a passage included in the parking area.

11. A vehicle guidance program product stored in a computer-readable non-transitory storage medium, the vehicle guidance program product comprising instructions to be executed by at least one processor of a control device used in an automated valet parking lot, the instructions comprising:
determining an availability of a parking section included in a parking area, the parking area being defined as an area in which an autonomous driving of a vehicle is executed according to a guidance of the control device within the automated valet parking lot;
guiding an entrance vehicle to the parking section according to the determined availability of the parking section, the entrance vehicle corresponding to the vehicle that requests an entrance to the parking section; and
in response to determining that the parking section is unavailable, guiding the entrance vehicle to a passage included in the parking area.
